(19) United States
(12) Patent Application Publication
(10) Pub. No.: US 2015/0186801 A1
(43) Pub. Date: Jul. 2, 2015

(54) LICENSE CONTROL

(71) Applicant: Hangzhou H3C Technologies Co., Ltd., Hangzhou (CN)

(72) Inventor: Changxuan CUI, Beijing (CN)

(21) Appl. No.: 14/577,459

(22) Filed: Dec. 19, 2014

(30) Foreign Application Priority Data
Dec. 30, 2013 (CN) 201310752212.0

(51) Int. Cl. G06Q 10/00; G06Q 50/18

(52) U.S. Cl. CPC G06Q 10/00; G06Q 50/184

(57) ABSTRACT

A moment for generating an effective period of a product license is determined, a calculation method for calculating the effective period of the product license is determined; and an expiry time of the product license is calculated according to the calculation method for calculating the effective period when the moment for generating the effective period is reached.

### BACKGROUND

Currently, vendors use a product by license to control use of and access to a product. For instance the product license may control which features of a product may be used, the number of resources that may use or be managed by the product, and to impose a time limit on usage of the product. In addition, a product may include a variety of functions. In some circumstances, in order to save money a user may purchase a license which gives permission to activate the basic functions of a product, but does not give permission to activate other features of the product. The user may later purchase and activate a new license to gain access to more functions of the product.

One issue for vendors is how to control the effective period of the product license, i.e. the period for which the license is valid. For instance, a user may be able to use a product from an activation time of the product until an expiry time of the license. However, the different users may have a different demands regarding the activation time of the product. In addition, the vendors may have different sales strategies for their products, such as whether or not to provide a trial version of a product. Also, vendors may configure different license durations for different users.

### BRIEF DESCRIPTION OF THE DRAWINGS

FIG. 1 is a flowchart of the product license control method according to an example of the present disclosure.

FIG. 2 is a flowchart showing the initialization of the attributes of the effective period of the product license when the authorization code is generated according to an example of the present disclosure.

FIG. 3 is a flowchart showing the configuration of the effective period upon license activation according to an example of the present disclosure.

FIG. 4 is a hardware architecture diagram of the equipment for the license control logic according to an example of the present disclosure.

FIG. 5 is a functional block diagram of the license control logic according to an example of the present disclosure.

### DETAILED DESCRIPTION

When the functions and the number of managed resources of a product are provided to the users, it is needed to control the permissions of the products via a license. In addition to the product functions and the number of managed resources, the effective period of the product may also be controlled. For the current solutions, the effective period of the product license is calculated by software embedded in the product. That is, the calculation method of the activation time and the expiry time of the product license are configured within software embedded in the product itself for calculating the effective period of the product license.

Generally, there are two license control solutions may be adopted by the vendors.

The first solution is to calculate the effective period of the product license when the license authorization code is generated. Before the product is delivered to an user, the activation and expiry time of the product license are configured upon the authorization code generated. For instance, the activation time of the product license may be configured by adding a specific time period from the generating time of the authorization code. The expiry time of the product license may be configured by adding an effective period of the product license from the activation time of the product license. The effective period is configured in accordance with the users' demands.

The second solution is to calculate the effective period of the product license when the license is activated upon requesting by an user. The activation time of the product license is the current time in accordance with the users' request. The expiry time of the product license is the activation time of the product license plus the effective period of the product license.

According to the above two solutions, once the effective period of the product license is configured, the effective period cannot be adjusted in accordance with the sale strategies or the demand of an user. For instance, for the first solution, the effective period may be wasted if an user has not begun to use the products in the pre-determined activation time. In addition, the user may request the vendor to compensate the loss of the effective period if the products are delayed by unpredictable factors, which may require the vendor to re-generate the license of the product. With respect to the second solution, for the scenario that the product may be planned for usage for multiple sites, the effective period may be wasted as the product may not be completely deployed for all of the sites. For example, the constructing time of a user IT system in different sites may be different. A product, such as VSR (Virtual Server Router), which may charge fee according to the number of the managed node resources and be deployed on these different sites is activated in one of these sites according to the second solution, thus the effective period may be wasted in other sites in which the product has not be used after activation.

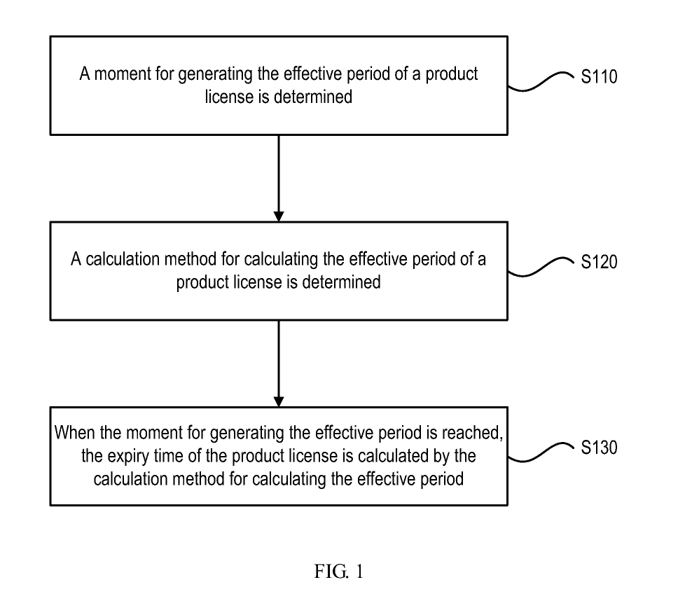

In view of the above, a license control method according to the present disclosure is provided as shown in FIG. 1.

At block S110, a moment for generating the effective period of a product license is determined.

According to the present disclosure, the moment for generating the effective period means the moment for configuring the activation time and expiry time of the product license. The effective period is the period for which the license is valid. The effective period ends at an expiry time of the license. In different scenarios, the moment for generating the effective period may vary. For instance, the moment for generating the effective period may be the time at which the product is configured. Namely, the effective period of the product license may be determined when the product is configured. In another example, the moment for generating the effective period may be upon generation of the authorization code. In another more example, the moment for generating the effective period may be upon product activation. In this example, the activation time of the product license may be determined by the product user as the effective period of the product license does not start until the product is activated by the user. It is noted that, the product may be activated after the product is installed or at any time according to the demand of the user. In addition, the whole product may be activated or partial functions of the product may be activated without activating the whole product.

At block S120, a calculation method for calculating the effective period of a product license is determined.

There may be several different possible methods of calculating the effective period of the product license and one of the possible methods is selected.

According to the present disclosure, the calculation method of the effective period means a concrete method for determining the activation time and the expiry time of the product license. The activation time and expiry time of the license may be calculated in accordance with a variety of methods so as to further increase the flexibility of the product license control.

For instance, the calculation method of the effective period may include two different solutions in accordance with the activation time of the product, such as an absolute time solution and a relative time solution. With respect to the absolute time solution, it means that the activation time of the product license is determined by the absolute time designed by vendors or users. The expiry time of the product license may be the absolute activation time plus the predetermined period of the effective period. Also, the activation time of the product license may be configured to the designated absolute time plus the delay period by vendors or users. Correspondingly, the expiry time may be the designated absolute time plus the delay period and the predetermined period of the effective period.

With respect to the relative time solution, it means that the activation time of the product license is determined by a current time for generating the effective period. For instance, the current time is taken as the activation time of the product license. As such, the expiry time of the product license may be the current time plus the predetermined effective period. In another example, the activation time of the product license may also be configured to the current time plus the delay period. Correspondingly, the expiry time may be the current time plus the delay period and the predetermined period of the effective period.

At block S130, when the moment for generating the effective period is reached, the expiry time of the product license is calculated by the calculation method for calculating the effective period.

For instance, when the moment for generating the effective period is set as the time of product configuration, the activation time may be the absolute time designated by vendors or may be the current absolute time of the product activated. In an example, if the activation time may be the absolute time plus the delay period, and the expiry time may be the activation time plus the predetermined period of the effective period and the delay period. When the moment for generating the effective period is determined upon the authorization code generated. Under the circumstance, assuming that the absolute current time, at which the authorization code is generated, is taken as the activation time, as such, the expiry time is calculated by adding the activation time and the predetermined period of the effective period.

The predetermined period of the effective period may be embedded in the software within the product or may be configured by vendors in accordance with the real scenarios. The effective period of the product license may include the activation time and the expiry time of the product license. When the current absolute time is taken as the activation time, the expiry time is calculated with the predetermined period of the effective period. Because the vendors are provided with the opportunities for configuring the activation time of the product license or how to activate the product license. As such, the activation time and the expiry time of the product license may be feasibly controlled in accordance with the sales' strategies and the demand of the user. In addition, the product license configuration may also be modified in accordance with the real scenarios, which contributes to the feasibility of the product license.

In another example, when the moment for generating the effective period is determined upon product activation, the user is provided with the opportunities for configuring the activation time of the product license. In the example, the moment for generating the effective period, the calculation method for calculating the effective period with pre-determined period, and the calculation of the activation time and expiry time of the product license will be described hereinafter.

In the example, the moment for generating the effective period is determined upon product activation. When an user adopts an absolute time solution as the calculation method of the effective period, the effective period of the product license is calculated basing on the designated absolute time inputted by the users. For instance, the designated absolute time is taken as the activation time. The expiry time of the product license is calculated by adding the activation time and the predetermined period of the effective period. In another example, the activation time is the designated absolute time plus the delay period. Thus the expiry time of the product license is calculated by adding the designated absolute time plus the predetermined period and the delay period. In other examples, given the absolute time is designated by the user, the activation time may be the activation time of a specific function of the product so as to calculate the expiry time of the product license. The expiry time of the product license may be calculated in accordance with the designated absolute time, and the pre-determined period of the effective period.

In order to prevent the user from inputting an absolute time earlier than the current time, the method also determines whether the designated absolute time is later than the current time. If yes, the inputted absolute time is taken as the absolute activation time. Otherwise, the user is notified of the erroneous time inputted.

Compared to the conventional solutions in which the product license is activated upon the product activation, the activation time of the product license in the example may be defined when the product license is activated. In addition, the expiry time may be calculated accordingly. As such, the effective period of the product license may be feasibly controlled in accordance with real scenarios.

The present disclosure may be implemented via an independent application software (hereinafter referred as “first software”). Comparing to the current solution, the parameters regarding the effective period of the product license are not calculated by the embedded license software (hereinafter referred as “second software”) within the product. Instead, the first software may output the calculation result to the second software to implement the license control of the product. For example, under some circumstance, a NMS (network manage system software) running in a server may be taken as the first software, the NMS may output the parameters of the effective period, such as the activation time, the pre-determined period of the effective period and the calculated method, to the second software. Thus the second software can generate the product license according the results. Therefore, a more flexible license control can be realized wherein the calculation result is directly adopted by the software embedded within the product to control the license.

The method for controlling the effective period of the product license by a license will be described hereinafter. The method may be implemented in one of these scenarios, such as license configuration, authorization code generation, license activation, license expiry, and license modification. The moment for generating the effective period may be in the product configuration, authorization code generation, or the authorization code activation. The calculation method of the effective period may include the absolute time solution and the relative time solution.

1. In the Circumstance of The License Configuration

Under this circumstance,

The method include the following configures: The default value of the effective period is permanent. That means that the license does not expire. Otherwise, a concrete effective period including an activation time and expiry time should be configured.

When the value of the effective period is not permanent, a calculating method is used to determine the effective period. There are two solutions for configuring calculating method of the effective period. With respect to the absolute time solution, the activation time of the product license is configured in accordance with the designated input by vendors. With respect to the relative time type, it is needed to further configure the delay period. The default value for the delay period is zero, and it can be understood that the default value of the delay period may be adjusted accordingly.

When the value of the effective period is not permanent, the moment for generating the effective period of the product license may be set. Generally, there are three moments for generating the effective period:

(1) The moment for generating the effective period is the time at which the product is configured. When the calculation method for calculating the effective period is of the absolute time solution, the vendors may further configure the activation time of the product license. Correspondingly, the expiry time may be set as the activation time plus the pre-determined period of the effective period. When the calculation method for calculating the effective period is of the relative time type, the default activation time of the product license is set as the current time plus the delay period. The expiry time is set as the activation time plus the predetermined period and the delay period.

(2) The moment for generating the effective period is the time at which the authorization code is generated. When the calculation method for calculating the effective period is of the absolute time type, the activation time is configured by the vendors generating the authorization code. The expiry time may be set as the activation time plus the predetermined period of the effective period. When the calculation method for calculating the effective period is of the relative time type, the default activation time of the product license is the set as current time generating the authorization code plus the delay period. The expiry time is set as the activation time plus the predetermined period and the delay period.

(3) The moment for generating the effective period is the time at which the product is activated. When the calculation method of effective period is of the absolute time solution, the activation time of the product license is configured by the users applying for the product activation. The expiry time is set as the activation time plus the predetermined time of the effective period. When the calculation method of effective period is of the relative time solution, the default activation time of the product license is set as the current time of activating the product plus the delay period. The expiry time is set as the activation time plus the predetermined period and the delay period.

2. In the Circumstance of Generating an Authorization Code

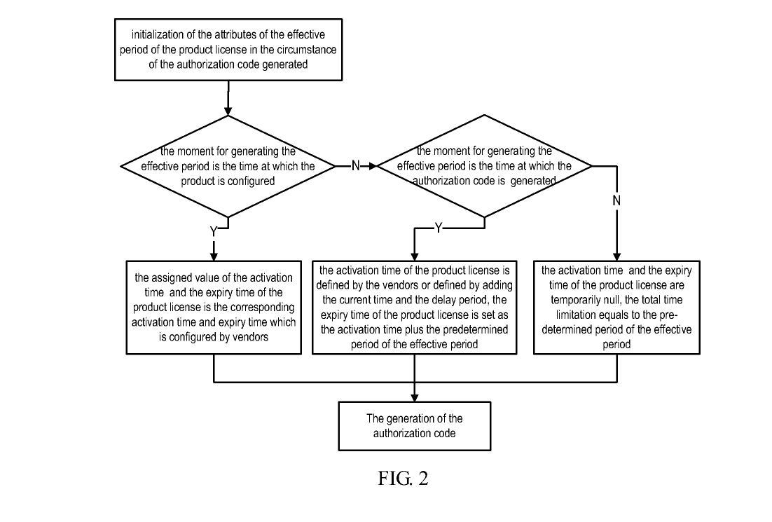

FIG. 2 is an example flowchart showing the initialization of the attributes of the effective period of the product license in the circumstance of the authorization code generated.

When the moment for generating the effective period is the time at which the product is configured, the assigned value of the activation time of the product license is the corresponding activation time configured by vendors. The assigned value of the expiry time of the product license is the corresponding expiry time configured by vendors. Thus, the product license has a total time limitation (t) that the product may be used, which is initially equal to the pre-determined period of the effective period. In addition, the product license may also store an effective remaining period (r) that indicates how much longer the license will remain valid for. Furthermore, the effective period of the license is initially configured the total time limitation (t) is equal to the effective remaining period (r). At subsequent times the effective remaining period is reduced by the period of time for which the license has been active.

When the moment for generating the effective period is the time at which the authorization code generation, the activation time of the product license is defined by the vendors or defined by adding the current time and the delay period. The total time limitation (t) is the pre-determined period of the effective period configured for the product license, and the total time limitation (t) is initially equal to an effective remaining period (r). The expiry time of the product license may be the activation time of the product license plus the total time limitation (t).

When the moment for generating the effective period is the time at which the product is activated, the activation time of the product license is null. The total time limitation (t) may be the pre-determined period of the effective period configured for the product license, and the total time limitation (t) initially equals to an effective remaining period (r). The expiry time is null.

3. In the Circumstance of a Product Activated

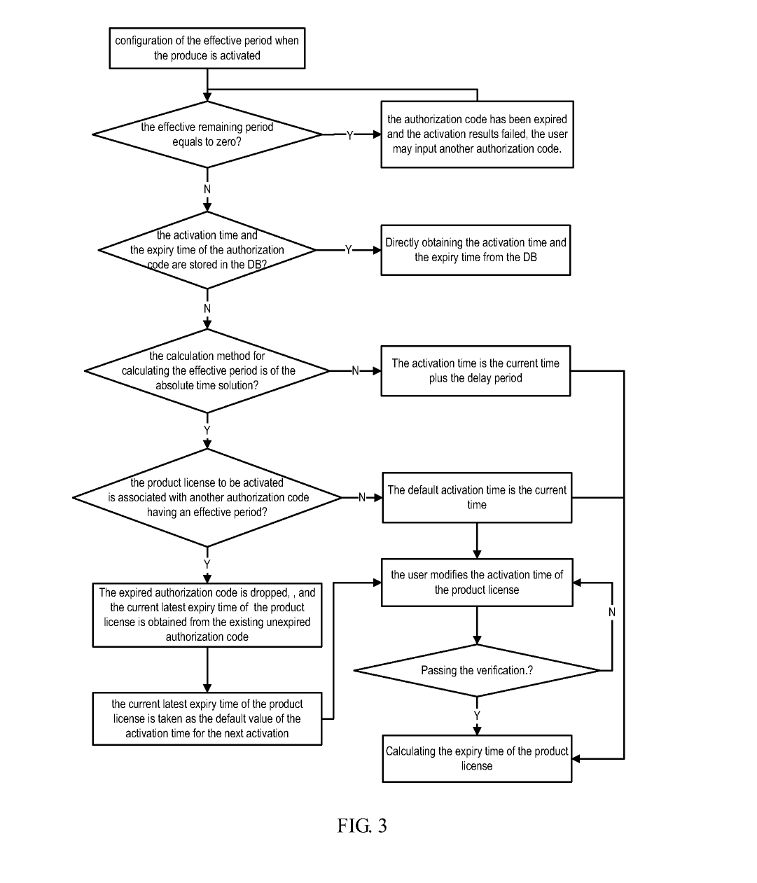

FIG. 3 is an example flowchart showing the configuration of the effective period at the time at which the produce is activated.

First, the effective remaining period (r) corresponding to a new authorization code inputted by the user is verified. When the effective remaining period (r) equals to zero, it is determined that the authorization code has been expired and the activation results failed. Under this circumstance, the user may input another authorization code.

Second, when the activation time and the expiry time of the authorization code are stored in the database, it can be understood that the moment for generating the effective period may be determined at the time at which the product is configured or at which the authorization code is generated. Under the circumstance, the original activation time and the expiry time may be obtained from the database directly.

Third, when the activation time and the expiry time of the authorization code are not stored in the database, it can be understood that the moment for generating the effective period may be determined at the time at which the product is activated. Under the circumstance, if the calculation method for calculating the effective period is not of the absolute time solution, the default activation time may be set as the current time plus the delay period.

Fourth, when the activation time may be inputted by the user, a determination is made regarding whether the product license applying for the activation has been associated with another authorization code which has indicative of another effective period of the license running on the same product. If not, the default activation time is the current time. Otherwise, the expired authorization code is dropped, and the current latest expiry time of the product license is obtained from the existing unexpired authorization code. In the example, the current latest expiry time of the product license is taken as the default value of the activation time for the next activation.

Fifth, after the user has inputted the modified activation time, a determination is made regarding whether the activation time is not earlier than the current day.

Sixth, the expiry time of the product license is calculated according to the effective remaining period (r)as described above.

In the example, when there may be the activation has to be approved or there may be other delayed factors, the activation time of the product license may be adjusted accordingly.

(4) In the Circumstance of Activated License Stopped Use

When an activated product need to temporarily stop using because of some reasons, the unexpired authorization code may be modified to be indicative of the status for which the product has been delivered but has not been activated. Meanwhile, the Value [r] of the product is stopped updating to avoid the time loss of the user of the product.

(5) In the Circumstance of a License Authorization Modification

Under the circumstance, the license activation of the original product is cancelled. Afterward, the new product is activated by: (1) A valid authorization code is obtained using the same rules with the product for activation. The expired authorization code that has been activated on the product is dropped. (2) The activation time and the effective remaining period (r) corresponding to the authorization code of the original product remain the same.

(6) In the Circumstance Of Automatically Maintaining the Data and Status of the Effectiveness of the Authorization Code

The effective remaining period (r) of the activated authorization code is refreshed in a routine manner, such as being refreshed every day. If the date executing the routine process is later than the current date, the method for calculating the effective remaining period (r) executes the function “r=r−1”. When r equals to zero, the authorization code is determined as being expired.

In another example, the license of three products, numbered as item01, item02, and item 03, needed to be controlled. The vendors may configure the products on Nov. 1, 2013. First, the pre-determined period of the effective period is configured. If the pre-determined period of the effective period for the product license of item01 is one year, thus the effective period is set as 365 days. Additionally, assuming the pre-determined period of the effective period for the product license of item02 is set as 30 days, and the pre-determined period of the effective period for the product license of item03 is set as 90 days

The calculation method of the effective period is also configured in this scenario. Item01 is configured to be of the absolute time solution. Item02 is configured to be of the relative time solution and the delay period is 60 days. Item03 is configured to be of the absolute time solution.

Afterward, the moment for generating the effective period is determined.

(1) The moment for generating the effective period for Item01 is determined the time at which the product is configured. As the calculation method for calculating the effective period is of the absolute time solution, assuming the vendors configure the activation time to be Jan. 1, 2014. As such, the expiry time may be automatically calculated as Jan. 1, 2015. This configuration is suitable for the scenario, such as a promoted short-term product, for which the effective period is fixed after the configuration.

(2) The moment for generating the effective period for Item02 is determined the time at which the authorization code is generated. The activation time and the expiry time are temporarily null. This configuration is suitable for regular products that are often lead by the vendors.

(3) The moment for generating the effective period for Item03 is determined the time at which the product is activated. The activation time and the expiry time are temporarily null. This configuration is suitable for regular products that are often lead by the users.

In this example, the three products are further assumed that all of the authorization codes for the three products are generated on Nov. 15, 2013.

(1) The item01 may generate the authorization code “lic01” according to the information obtained from the product configuration. The activation time of the product license is Jan. 1, 2014. The expiry time of the product license is Jan. 1, 2015. The total time limitation (t) equals to the pre-determined period of the effective time, i.e., 365 days, which initially equals to the effective remaining period (r).

(2) The item02 may generate the authorization code “lic02.” The activation time of the product license is 60 days after Nov. 15, 2013, i.e., Jan. 14, 2014. The expiry time of the product license is 30 days after the activation time, i.e., Feb. 13, 2014. The total time limitation (t) equals to the pre-determined period of the effective period, i.e., 30 days, which initially equals to the effective remaining period (r).

(3) The item03 may generate the authorization code “lic03.” The activation time of the product license is null. The total time limitation (t) equals to the pre-determined period of the effective period, i.e., 90 days, which initially equals to the effective remaining period (r).

After the product is delivered, the user applies for the license activation on Dec. 1, 2013. The three products are first activated at the same time.

(1) The effective remaining period (r) corresponding to the three authorization codes are larger than zero, and thus are capable of passing the verification.

(2) The activation time and the expiry time of the product license for lic01 and lic02 may be directly obtained due to they are stored in the database.

(3) The authorization code “lic03” requires the user to input the activation time of the product license to determine whether the product is associated with the other products of the database which has a time limitation of the same authorization code indicative of another effective period of the product license on the same product . If yes, the expired authorization code needs to be dropped and the latest expiry time of the existing unexpired authorization codes is taken as the default activation time of the product license. In this example, assuming that there is no unexpired authorization code, the defaulted time of generating the authorization code is Dec. 1, 2013. The user has designated to activate the authorization code on Feb. 1, 2014. The activation time of the product license is Feb. 1, 2014. The expiry time of the product license is 90 days after the activation time, i.e., May 2, 2014. The total time limitation (t) equals to 90 days, which initially equals to the effective remaining period (r).

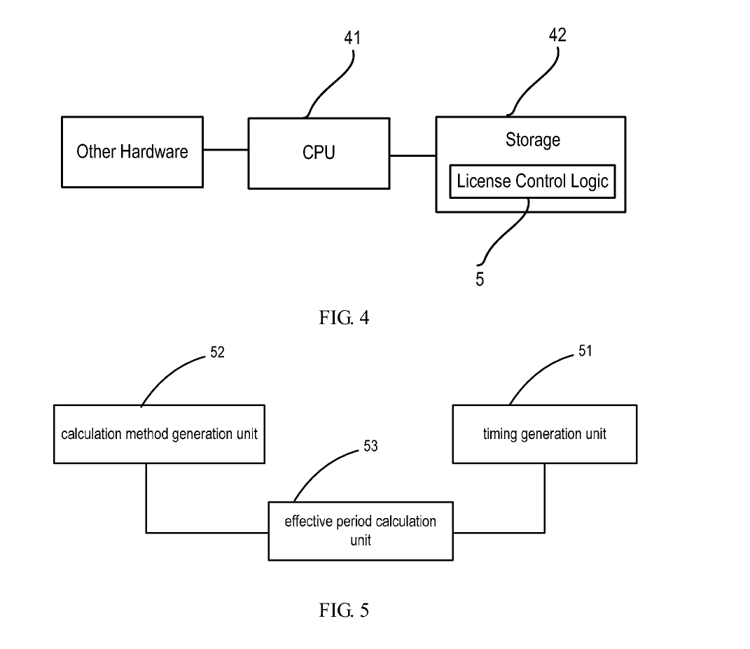

Corresponding to the above process, a logic for controlling the product license is also disclosed. The logic may be implemented by software, hardware, or a combination of the software and the hardware. In various examples, the logic may be operated on an equipment has a variety of control functions of the product license. In terms of the hardware, as shown in FIG. 4, the equipment having the license control functions includes a CPU 41, a storage 42, and other hardware for implementing regular functions of the device. Additionally, the equipment may also be a distributed device in other examples.

A shown in FIG. 5, the license control logic 5 includes a timing generation unit 51, a calculation method generation unit 52, and a effective period calculation unit 53. The timing generation unit 51 is configured for determining the moment for generating the effective period of the product license. The calculation method generation unit 52 is configured for determining the calculation method of the effective period. The effective period calculation unit 53 is configured for calculating the expiry time of the product license according to the calculation method for the effective period when the moment for generating the effective period is reached.

In an example, the license control logic 5 is implemented by an instruction set, i.e., machine-readable instructions which are stored in the storage 42. The CPU 41 may read the machine readable instructions from the storage 42 and then execute the logic described hereinafter.

Determining the moment for generating the effective period of the product license.

Determining the calculation method for calculating the effective period of the product license.

Calculating the expiry time of the product license according to the calculation method of the effective period when the moment for generating the effective period is reached.

The CPU 41 may read the machine readable instructions from the storage 42 and then execute the logic for calculating the effective period of the product license as following.

The effective period of the product license may be calculated by an absolute time solution. That is, a designated absolute time is taken as the activation time of the product license. The expiry time may be set as the designated absolute time plus the predetermined period of the effective period for the product license. In another example, the activation time may be set as the designated absolute time plus the delay period. The expiry time may be the designated absolute time plus the predetermined period and the delay period.

The effective period of the product license may be calculated by a relative time solution. That is, the current time is taken as the activation time of the product license. The expiry time of the product license is calculated by adding the current time and the predetermined period of the effective period for the product license. Alternatively, the activation time may be the current time plus the delay period. The deactivation time may be set as the current time plus the predetermined period and the delay period.

Furthermore, the CPU 41 may read the machine readable instructions from the storage 42 and then execute the logic 5 for determining the moment for generating the effective period of the product license. The moment may be in the product configuration period, the authorization code generation period, or the activation period.

In an example, the CPU 41 may read the machine readable instructions from the storage 42 and then execute the logic 5 for determining the moment for generating the effective period of the product license to be in the activation period. The CPU 41 may read the machine readable instructions from the storage 42 and then execute the logic 5 for calculating the effective period for the product license. Wherein the activation time may be the designated absolute time inputted by the user. The expiry time may be set as the designated absolute time plus the predetermined period of the effective period for the product license. In another example, the activation time may be the designated absolute time plus the delay period. The expiry time may be set as the designated absolute time plus the predetermined period and the delay period of the product license.

With respect to the conventional solution, the effective period of the product license is fixed after the product is manufactured. Comparing to the conventional solution, the activation time and the expiry time of the product license may be flexibly controlled by vendors or users in accordance with the sales and/or real scenarios. In addition, the original configuration may also be modified according to the real scenarios, which greatly enhance the flexibility of the product license control.

The foregoing descriptions are some examples of the present disclosure and are not for use in limiting the protection scope thereof. Any modification, equivalent replacement and improvement made under the spirit and principle of the present disclosure should be included in the protection scope thereof.

1. A license control method executed by a computer, the method comprising:
determining a moment for generating the effective period of a product license;
determining a calculation method for calculating the effective period of the product license; and
when the moment for generating the effective period of the product license is reached, calculating the expiry time of the product license according to the calculation method for calculating the effective period.

2. The method as claimed in claim 1, wherein the calculation method of the effective period comprises:
setting a current time as an activation time of the product license, and setting the activation time plus a predetermined period of the effective period for the product license as the expiry time of the product license; or
setting the current time plus a delay period as the activation time of the product license and setting the current time plus a predetermined period and the delay period as the expiry time of the product license.

3. The method as claimed in claim 1, wherein the calculation method of the effective period of the product license comprises:
setting a designated absolute time as an activation time of the product license, and setting the designated absolute time plus a predetermined period of the effective period for the product license as the expiry time of product license; or
setting the designated absolute time plus a delay period as the activation time of the product license, and setting the designated absolute time plus the predetermined period and the delay period as the expiry time of the product license.

4. The method as claimed in claim 1, wherein the moment for generating the effective period of the product license is set as the time at which the product is configured, the time at which the authorization code for the product is generated, or the time at which the product is activated.

5. The method as claimed in claim 1, when the moment for generating an effective period of the product license is the time at which the product is activated, the effective period of the product license is calculated by:
setting a designated absolute time inputted by a user as the activation time of the product license, and setting the activation time plus a predetermined period of the effective period for the product license as the expiry time of the product license; or
setting a designated absolute time input by a user plus a delay period as the activation time of the product license, and setting the activation time plus a predetermined period and the delay period as the expiry time of the product license.

6. A computer readable non-transitory storage medium storing license control logic executable by a processor to:
determine a moment for generating an expiry time of a product license;
determine a calculation method of the expiry time of the product license; and
when the moment for generating the expiry time is reached, calculate the expiry time of the product license according to the calculation method for calculating the effective period.

7. The computer readable non-transitory storage medium as claimed in claim 6, wherein the instructions are fetched by the CPU to:
set a current time as an activation time of the product license, and set the current time plus a predetermined period of the effective period as the expiry time of the product license; or
set the current time plus a delay period as an activation time of the product license, and set the current time plus a predetermined period and the delay period as the expiry time of the product license.

8. The non-volatile storage medium as claimed in claim 6, wherein the instructions are fetched by the CPU to:
set a designated absolute time as an activation time of the product license, and set the designated absolute time plus a predetermined period of the effective period as the expiry time of the product license; or
set the designated absolute time plus a delay period as the activation time of the product license, and set the designated absolute time plus a predetermined period and the delay period as the expiry time of the product license.

9. The non-volatile storage medium as claimed in claim 6, wherein the moment for generating an effective period of the product license is within a product configuration period, an authorization code generating period, or an activation period.

10. The non-volatile storage medium as claimed in claim 6, wherein when the moment for generating an effective period of the product license is within the activation period, the instructions are fetched by the CPU to calculate the effective period by:
set a designated absolute time inputted by users as the activation time of the product license, and set the designated absolute time plus a predetermined period of the effective period as the expiry time of the product license; or
set a designated absolute time inputted by users plus a delay period as the activation time of the product license, and set the designated absolute time plus a predetermined period and the delay period as the expiry time of the product license.
